(19) United States
(12) Patent Application Publication
(10) Pub. No.: US 2026/0310629 A1
(43) Pub. Date: Oct. 8, 2026

(54) OPTIMIZED DATA ARCHIVAL

(71) Applicant: Dell Products L.P., Round Rock, TX (US)

(72) Inventors: Prakash Revansidhappa Bhurke, Pune (IN); Kaushik Gupta, Pune (IN)

(21) Appl. No.: 19/171,691

(22) Filed: Apr. 7, 2025

(51) Int. Cl. G06F 16/11

(52) U.S. Cl. CPC G06F 16/113

(57) ABSTRACT

Presented is a strategy for optimizing data archival. For instance, a method can comprise: retrieving, from storage equipment, a storage object comprising a group of files, based on using a manifest structure included at a head end the storage object, de-serializing the storage object to extract a file of the group of files, creating an updated file comprising original data and updated data, amending the manifest structure to include a note that the extracted and now updated file is no longer a member of the group of files included in the storage object, and transmitting the storage object to the storage equipment.

### BACKGROUND

Object storage equipment is a fundamental technology behind modern cloud computing, enabling businesses to store and retrieve massive datasets efficiently and reliably. Object storage equipment implements storage architecture(s) that manage and manipulate data as objects rather than traditional file or block storage. Generally, each object associated with object storage equipment can include: data (e.g., actual file(s) and/or data being stored); metadata (e.g., information regarding the data, such as permissions, creation date, and/or custom attributes); and unique identifier addresses that allow a system to identify, locate, access, and/or retrieve the object.

Object storage equipment is typically designed for virtually unlimited storage, making object storage ideal for cloud-based and large-scale applications. Object storage equipment further allows for detailed tagging and classification of objects for easy retrieval and organization. Additionally, object storage systems ensure durability and redundancy by distributing the data across multiple locations, thereby ensuring protection again failures. Further, unlike typical file systems, objects in object storage equipment can be stored in a flat namespace, making retrieval efficient via unique identifiers.

Data archival is essential for organizations that balance storage costs, regulatory requirements, and long-term data preservation while ensuring accessibility when needed or requested. Data archival is the process of moving infrequently accessed data from primary storage to a long-term storage solution for cost efficiency, compliance, and data preservation. Unlike backups, which are meant for disaster recovery, archived data is retained for future reference, regulatory requirements, or historical purposes.

For purposes of data archival: data generally is stored for extended periods, often years or decades (e.g., long term retention); for cost-efficiency purposes, archived data is persisted to lower-cost storage solutions compared to primary storage; ensures adherence to industry and governmental regulations, such as the health insurance portability accountability act (HIPAA), general data protection regulation (GDPR), and other governmental and industry best practices; and further ensures that archived data is accessible when needed but typically not in real-time.

Common storage solutions currently used for long term persistence of archived data include, for example: cloud-based archival facilities, tape storage for high-capacity low-cost storage, optical storage such as write-once, read-many (WORM) media for data integrity, and on-premise-storage such as network-attached storage (NAS) or dedicated archival systems.

### BRIEF DESCRIPTION OF THE DRAWINGS

Non-limiting embodiments of the subject disclosure are described with reference to the following figures, wherein like reference numerals refer to like parts throughout the various views unless otherwise specified:

FIG. 1 illustrates a block diagram of a system for optimizing data archival to archival equipment, in accordance with various non-limiting example embodiments.

FIG. 2 illustrates a method, flow chart, or time sequence, for optimizing data archival to archival equipment, in accordance with various non-limiting example embodiments.

FIG. 3 illustrates a further method, flow chart, or time sequence, for optimizing data archival to archival equipment, in accordance with various non-limiting example embodiments.

FIG. 4 depicts another method, flow chart, or time sequence, for optimizing data archival to archival equipment, in accordance with various non-limiting example embodiments.

FIG. 5 illustrates an additional method, flow chart, or time sequence, for optimizing data archival to archival equipment, in accordance with various non-limiting example embodiments.

FIG. 6 depicts an illustrative storage object for optimizing data archival to archival equipment, in accordance with various non-limiting example embodiments.

FIG. 7 depicts another illustrative storage object for optimizing data archival to archival equipment, in accordance with various non-limiting example embodiments.

FIG. 8 depicts further illustrative storage object for optimizing data archival to archival equipment, in accordance with various non-limiting example embodiments.

FIG. 9 depicts an additional illustrative storage object for optimizing data archival to archival equipment, in accordance with various non-limiting example embodiments.

FIG. 10 illustrates a cloud storage system, such as an elastic cloud storage (ECS) system, in accordance with various non-limiting example embodiments.

FIG. 11 illustrates a block diagram representing an illustrative non-limiting computing system or operating environment in which one or more aspects of various non-limiting embodiments described herein can be implemented.

### DETAILED DESCRIPTION

Example embodiments of the subject disclosure will now be described more fully hereinafter with reference to the accompanying drawings in which example embodiments are shown. In the following description, for purposes of explanation, numerous specific details are set forth in order to provide a thorough understanding of the various embodiments. However, the subject disclosure may be embodied in many different forms and should not be construed as limited to the example embodiments set forth herein.

In accordance with various example embodiments, a system, apparatus, or device is provided comprising: a processor; and a memory that stores executable instructions that, when executed by the processor, facilitate performance of operations. The operations can comprise: receiving a group of files that have been indicated as being candidates for storage to cloud storage equipment, determining whether a file in the group of files has a file size that is less than a defined file size threshold value, in response to the determining indicating that the file size is less than the defined file size threshold value, grouping the file into one or more associative groups based on one or more associations that exist between the file and each other file in the group of files, based on the one or more associative groups, packing the file into a storage object of a defined length, in response to the packing of the file into the storage object, updating a stitching object with stitching data representing the file placed into the storage object, and transferring the stitching object to the cloud storage equipment.

Additional operations can comprise monitoring the packing of the file into the storage object to ensure that the defined length of the storage object is not exceeded. In embodiments where the file is a first file, the operations can comprise using a data structure to maintain associative linkages between the first file and a second file that are included in the storage object, wherein the associative linkages represent associations between the first file and the second file. In embodiment instances where the file is a first file and the storage object is a first storage object, the operations can comprise using a data structure to maintain associative linkages between the first file included in the first storage object and a second file that is included in a second storage object, wherein the associative linkages represent associations between the first file and the second file.

In some embodiments the operations can comprise in response to the determining indicating that the file size exceeds the defined file size threshold value, fragmenting and grouping the file into the one or more associative groups based on the one or more associations that exist between the file and each other file in the group of files. Additional operations can comprise packing the file into the storage object of the defined length, and in instant embodiments where the storage object is a first storage object and the file is a first file, the operations can comprise using a data structure to maintain associative linkages between the first file included in the first storage object and a second file that is included in a second storage object, wherein the associative linkages represent associations between the first file and the second file.

Concerning the foregoing, the stitching object can be a data structure that maintains attribute data associated with the file that is packed into the storage object.

In accordance with further embodiments, the subject disclosure describes a method, comprising a sequence of acts that can include: fetching, from storage equipment by equipment comprising one or more processors, a storage object comprising a group of files, based on using a manifest structure associated and included with the storage object, de-serializing, by the equipment, the storage object to extract a file of the group of files, creating, by the equipment, an updated file comprising old data representative of a previous version of the file and new data representative of a current version of the file newer than the previous version, amending, by the equipment, the manifest structure to include a record that the group of files does not comprise the file of the group of files used to create the updated file, re-serializing, by the equipment, the storage object to comprise the group of files exclusive of the file of the group of files used to create the updated file; and transmitting, by the equipment, the storage object to the storage equipment.

Other acts can comprise updating, by the equipment, associative links between the group of alternative files and other files included in the storage object. In embodiments where the storage object is a first storage object, the acts can comprise in response to the determining indicating that group of alternative files exceed the defined length associated with the first storage object, packing, by the equipment, the group of alternative files into a second storage object. In embodiments where the manifest structure is a first manifest structure, the acts can comprise updating, by the equipment, the first manifest structure to indicate that the group of alternative files have been included in the second storage object. In accordance with some embodiments the acts can comprise updating, by the equipment, a second manifest structure associated with the second storage object that the group of alternative files have been included in the second storage object, and updating, by the equipment, the first manifest structure and second manifest structure with associative linkage data representing that the group of alternative files are located in the second storage object and the group of files are situated in the first storage object.

In accordance with still further embodiments, the subject disclosure describes a machine-readable storage medium, a computer-readable storage device, or non-transitory machine-readable media comprising instructions that, in response to execution, cause a computing system comprising at least one processor to perform operations. The operations can comprise: retrieving, from storage equipment, a storage object comprising a group of files, based on using a manifest structure associated and included at a head end the storage object, de-serializing the storage object to extract a file of the group of files, creating an updated file comprising original data and updated data, changing the manifest structure to include a record that the file of the group of files used to create the updated file have been removed from the group of files included in the storage object. re-serializing or serializing the storage object without the file of the group of files used to create the updated file, and transmitting the storage object to the storage equipment.

Regarding the retrieving of the storage object from the storage equipment, the retrieving can be initiated by an archival process executing on one of the at least one processor. Further, the archival process can be a background process that becomes a foreground process at a defined time interval.

In some embodiments the operations can comprise, subsequent to the transmitting of the storage object to the storage equipment, waiting for a defined period of time for acknowledgement receipt data to be returned from the storage equipment, and wherein the acknowledge receipt data indicates that the storage object has been persisted to the storage equipment. Other operations can comprise, in response to not receiving the acknowledge receipt data within the defined period of time, re-transmitting the storage object to the storage equipment and setting a generic system clock timer for a defined time duration, and in response to not receiving the acknowledgement receipt data within the defined time duration, as determined by the generic system clock, moving the storage object into a temporary memory cache and initiating a back off time period measured by the generic system clock.

A cloud call (or cloud storage call) can be perceived as being an application programming interface (API) request or sequences of operations that can interact with a cloud storage service/platform (e.g., cloud storage equipment, archival equipment, . . . ). The cloud call can be a way to access, retrieve, upload, or manage data stored in cloud storage platforms. Common cloud calls, to name an illustrative few, can comprise: upload calls—calls that send files to cloud storage equipment (e.g., PUT requests); download calls—calls that retrieve files from cloud storage equipment (e.g., GET requests); delete calls—calls that remove files from cloud storage equipment (e.g., DELETE requests); list calls—calls that fetch listings of stored files or objects from cloud storage equipment (e.g., GET request on a directory); and metadata calls—calls that request, from cloud storage equipment, details about stored files e.g., file size, last modified date).

Archival of small files to the cloud (e.g., cloud storage equipment) can result in a plethora of distinct and separate (e.g., individual) calls to upload small objects. The plenitude of separate calls to upload small objects can have the resultant effect of increasing the total number of cloud calls. When cloud calls are performed in parallel (e.g., contemporaneously and/or in near contemporaneity with one another), a multitude of separate and individual cloud calls can have the potential to exceed one or more cloud request thresholds that can be included in service contracts imposed by purveyors of cloud storage facilities. For example, one vendor entity of cloud storage facilities has a defined threshold limit of 3500 requests per cloud storage bucket in parallel. It should be observed that since there can be multiple target paths in a defined bucket with multiple clusters/processes uploading data to different target paths in the same bucket, the defined threshold limit of 3500 requests per cloud storage bucket can be achieved extremely quickly.

A cloud storage bucket for purposes of cloud storage can be envisioned as a container used to store and organize data in a cloud storage facility. The cloud storage bucket can act as a top-level storage unit where users can store objects (files, data, and metadata). Cloud storage buckets are typically: scalable, in that they can store large amounts of data; provide object storage, storing data as objects (e.g., files together with associated metadata) in contrast to storing traditional files in traditional folder/sub-folder structures; provide global accessibility as stored data can be accessed from anywhere via the functionalities and facilities supplied the internet; users (e.g., user identities), using security and/or permission attributes can set access control policies and encryption on data; and provides versioning and lifecycle management functionalities that allow for the management of object versions and automating retention policies.

In accord with the foregoing, and in most detailed embodiments, a cloud storage bucket can comprise a logical container for storing objects (files, metadata, and other data) in cloud-based object storage systems. Wherein, unlike traditional file systems, where data is organized in hierarchical directories, buckets use a flat structure where each object has a unique identifier.

A cloud storage bucket can typically be structured as follows: each bucket can have a globally unique name (e.g., bucket name) within a cloud storage provider's system. For instance, the bucket name can be: my-data-bucket-2025. The cloud storage bucket can store objects which can include data representative of any file type (e.g., text, images, videos, audio, backups, etc.). Further, the objects can be associated with metadata (e.g., associated information) about the object, such as the object's size, creation date, encryption status, and the like. Bucket objects can be identified by a key (object name) within the bucket. For example, the cloud storage bucket can be identified as: my-data-bucket-2025, and the object name within the cloud storage bucket can be: backup/january-report.pdf. Additionally, cloud storage buckets can be associated with storage classes that can be used to determine cost, speed, and availability characteristics associated with each cloud storage bucket. Illustrative storage classes can include: standard class data indicative of a cloud storage bucket that comprises data representative of high-performance frequently accessed data; nearline class data indicative of a cloud storage bucket representing lower cost, best for infrequently accessed data; and coldline/archive class data indicative of inexpensive, for long-term, storage with infrequent access data.

Cloud storage buckets can also be associated with groups of permissions and access control attributes. Generally, cloud storage buckets can use identity and access management (IAM) roles and policies to control which user identities (e.g. who) can access cloud storage buckets and the groups of actions that they can perform. IAM roles and policies define permissions at different levels: such as: project level (e.g., grants permissions across all resources in a defined project); bucket level (e.g., grants permissions to a specific bucket); and object level (e.g., grants permissions on individual objects (files) within a specific bucket). It should be observed that IAM roles and policies provide public or private control access and granular permission for read, write, and delete actions. Common IAM permissions for cloud storage buckets can include, for example, create a new bucket; delete a bucket; view bucket details; list all buckets in a project; upload new files to a bucket; delete objects (files) from a bucket; download or view an object; and list all objects in a bucket.

Instead of assigning individual permissions, cloud storage providers generally employ groups of predefined IAM roles that can bundle multiple permissions together. Common predefined IAM roles for cloud storage buckets can comprise, for example: a storage admin role that can confer full control over storage buckets and objects; a storage object admin role that can confer full control over objects, but not the cloud storage buckets within which the objects are stored; a storage object creator role that allows the role holder to upload objects, but not to delete or read existing objects; a storage object viewer role that allows such a role holder the ability to read objects, but not to upload or delete the objects.

Further, cloud storage buckets can be structured to be associated with groups of lifecycle rules that can automate actions, for example, deleting old versions of objects and/or moving objects from relatively expensive storage to more inexpensive storage after defined periods of time. For instance, moving objects (and thereafter subsequently deleting old versions of objects) from: tape storage to optical storage (e.g., WORM) media, from optical storage media to on-premise-storage (e.g., such as NAS or dedicated archival systems).

Detailed and described herein, and in accordance with various embodiments, is an optimized archiving strategy operational on various physical equipment (and/or virtual machine instance representations of physical hardware equipment), wherein groups of small files that need to be archived and sent (uploaded) to cloud storage facilities/equipment are stitched together into single cloud storage objects. The cloud storage objects envisioned in this disclosure are of defined or definable sizes that typically can be significantly larger than any individual small file of the groups of small files, thereby reducing the overall quantum of cloud calls necessary to upload these individual small files to cloud storage equipment.

To date, and has been mentioned earlier, when small files have been archived to cloud storage equipment these small files have been uploaded as individuated small objects, resulting in an unnecessary proliferation and unneeded overabundance of cloud calls. As has also been observed, when cloud calls are performed in parallel the unneeded surfeit of cloud calls can exacerbate the proliferation of cloud calls so drastically that the number of cloud calls can rapidly exceed established threshold values.

To counter the foregoing, this disclosure describes gathering the plenitude of small files that need to be archived to form/create large single objects of defined sizes. In various embodiments, the plenitude of small files can be stitched (e.g., serialized and/or merged) with one another to form/create the large single objects. It has been observed by the inventors that in some implementations of cloud storage facilities controlled and/or managed by cloud storage operator (CSO) business entities that the largest permissible object that can be uploaded to cloud storage equipment, using a single PUT invocation, cannot exceed 5 gigabytes (GB).

With this in mind, the inventors propose and describe processes to merge and/or serialize small files of defined or definable size (e.g., not exceeding 1 GB) into a unitary storage object capable of being uploaded to cloud storage equipment using a single PUT operation. For instance, when a tranche (e.g., a division or portion of a pool or a whole) of small files identified as being candidates for archival to cloud storage is received, the disclosed systems and methods, detailed herein, can determine whether or not the size of each small file included in the tranche of small files exceeds or falls below a defined file size threshold value (e.g., 1 GB). In instances where the size of a small file falls below the defined file size threshold value (e.g., the file size is less than or equal to 1 GB), this small file can be identified as a candidate for inclusion into a stitched, merged, and/or serialized unitary storage object. In instances where the size of the small file exceeds (even marginally) the defined file size threshold value (e.g., the file size is greater than the 1 GB threshold value) this file, solely for purposes of exposition, can be termed and considered to be a “standard file,” and as such can be a candidate for a normal/standard PUT operation, wherein the “standard file” is uploaded to cloud storage equipment as a standard storage object using a single PUT operation.

It should observed that normal/standard files (e.g., “standard file”) generally do not necessarily undergo the disclosed stitching, merging, and/or serialization with other normal/standard files or, for that matter, other files (small files) that fail to surpass the defined file size threshold value (e.g., 1 GB); these “standard files” can be uploaded to cloud storage equipment “as is,” as an uploadable object (e.g., a single object that is capable of being uploaded) that can be in excess of 1 GB, but generally should not exceed the defined largest permissible object size value (e.g., 5 GB).

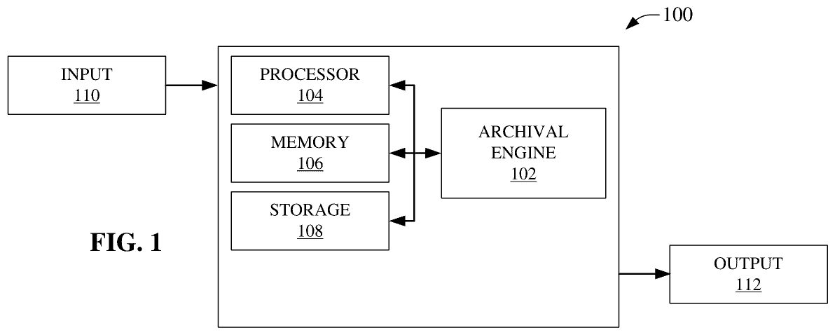

FIG. 1 depicts a system 100 for optimizing data archival in accordance with various example embodiments, in accordance with various non-limiting example embodiments. System 100, for purposes of illustration, can be any type of mechanism, machine, device, facility, apparatus, and/or instrument that includes a processor and/or is capable of effective and/or operative communication with a wired and/or wireless network topology. Mechanisms, machines, apparatuses, devices, facilities, and/or instruments that can comprise system 100 can include tablet computing devices, handheld devices, server class computing equipment, machines, and/or database equipment, laptop computers, notebook computers, desktop computers, cell phones, smart phones, consumer appliances and/or instrumentation, industrial devices and/or components, hand-held devices, personal digital assistants, multimedia Internet enabled phones, Internet of Things (IOT) equipment, multimedia players, and the like.

System 100 can comprise archival engine 102 that can be in operative communication with processor 104, memory 106, and storage 108. Archival engine 102 can be in communication with processor 104 for facilitating operation of computer-executable instructions or machine-executable instructions and/or components by archival engine 102; memory 106 for storing data and/or computer-executable instructions and/or machine-executable instructions and/or components; and storage 108 for providing longer term storage of data and/or machine-readable instructions and/or computer-readable instructions. Additionally, system 100 can also receive input 110 for use, manipulation, and/or transformation by archival engine 102 to produce one or more useful, concrete, and tangible results, and/or transform one or more articles to different states or things. Further, system 100 can also generate and output the useful, concrete, and tangible result and/or the transformed one or more articles as output 112.

Archival engine 102 can be implemented on frontend equipment, such as user equipment (UE), that can provide functionalities and/or facilities to access cloud storage equipment and its associated storage facilities and functionalities. Archival engine 102, in certain embodiments, can effectuate and facilitate the execution of executable archival processes at both cloud storage equipment and at the frontend equipment. It is to be understood, and persons having an ordinary skill in the art will appreciate, that the archival processes are processes in execution on one or processors associated with the frontend equipment, the cloud storage equipment, and/or both the frontend equipment and the cloud storage equipment.

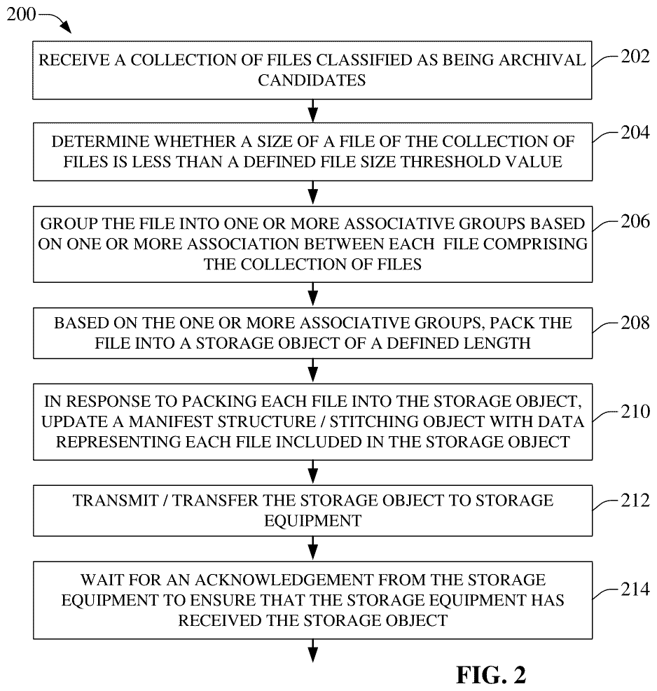

In some embodiments, and in reference to FIG. 2 (e.g., method 200 for optimizing data archival), an archival process executing on one of the cloud storage equipment and/or the frontend equipment (e.g., system 100, and in particular, archival engine 102) can receive, at act 202, a collection or grouping of files that can have been categorized (e.g., by an executing archival process) as being candidates for archival to cloud storage equipment. On receiving the collection or grouping of files, the archival process, at 204 can determine whether or not files included in the collection or grouping of files are less than a defined or definable threshold file size value (e.g., determine whether the files can be classified as being “small files,” wherein the defined or definable threshold file size value for small files, for purposes of exposition, can be set to 1 GB).

At act 206, the archival process executing on one of the cloud storage equipment and/or the frontend equipment can group the previously identified (e.g., act 204) “small files” into one more associative grouping based on one or more association that can exist between the small files included in the collection of files grouped as being “small files.” For example, in some embodiments, small files can be associated with other small files based on a commonality of ownership between each of the small files. In other embodiments, associations between small files can be based on dates of creation, dates of modification, and/or dates of access of the small files (e.g., files created, modified, and/or accessed by an owner role, or a process(s) with a common access right, within a defined or definable time period can be grouped with one another). In some other embodiments, associations can be made based on inter-associations (established connections) between first small files and a second small files, wherein the first small files comprise first executable code/data that are dependent on the second small files comprising second executable code/data. In additional and/or alternative embodiments, the small files can be classified or categorized based on attributes such as commonalities of security levels, commonalities in relation to archival periods associated with the small files (e.g., small files that have an archival expiration date of one year from a date certain-a defined date-can be grouped together), commonalities in relation to legal retention requirements (e.g., HIPAA, GDPR, and/or other governmental and/or industry best practices).

In regard to maintaining the various associations between identified small files, graph (e.g., undirected and/or directed graph structures); multi-graph (e.g., graph structures which are permitted to have multiple edges (or parallel edges); edges that can have the same end nodes); and/or hyper-graph (e.g., graph structures in which an edge can join any number of vertices) data structures that comprise groups of vertices (nodes) and edges (arcs) can be utilized. In regard to each of the graph structures (e.g., graph, multi-graph, and hyper-graph), each of the edges (or arcs), in certain embodiments, can also be associated with one or more weighting).

Further, in determining and establishing associations and commonalities between each of the determined small files, in some embodiment implementations, cost benefit analyses can be carried out to determine the costs associated with adopting a particular action can be compared with the benefits associated with adopting the action; where the benefits of adopting the action outweigh, even marginally, the costs associated with adopting the action, the action can be pursued. Further, in other additional and/or alternative embodiment implementations, artificial intelligence technologies, neural networking architectures, collaborative filtering processes, machine learning techniques, Bayesian belief systems, big data mining and data analytic functionalities, and the like, can be employed, wherein, for example, multi-objective optimization (e.g., Pareto optimization) can be used to determine whether or not an action should be initiated and implemented. Multi-objective optimization can ensure that first actions or groups of first actions can only be implemented provided that other second actions or groups of other second actions will not be detrimentally affected.

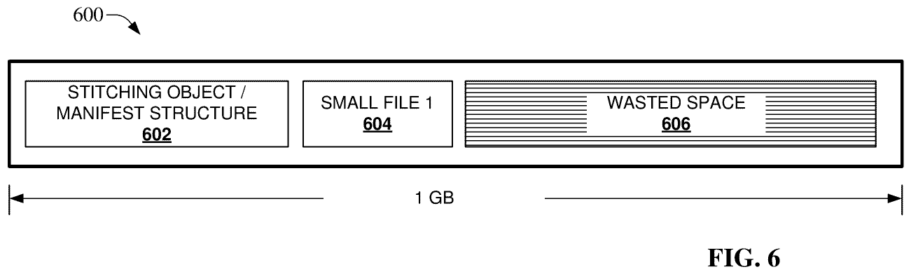

Archival engine 102, at act 208, using, for instance, the developed multi-graph data structures, can pack the files into a unitary storage object. As has been noted above the unitary storage object can be of a defined/fixed size (length). For purposes of this disclosure, the defined/fixed size can be 1 GB. Example unitary storage objects of a defined/fixed size are illustrated in FIGS. 6-9. At act 208, small files determined to be less than 1 GB and ordered/ranked based on relative sizes between each of the determine small files, categorized/grouped by their various associations can be included into one or more unitary storage objects. Archival engine 102, during the packing process can ensure that the 1 GB limit associated with the unitary storage object is not exceeded. For instance, where there are three associated “small files,” each having been determined as being approximately 500 megabytes (MB), the first “small file” and the second “small file” can be packed into a first unitary storage object of fixed size (e.g., 1 GB) and the third “small file” can be packed into a second unitary storage object. In this instance and for purposes of illustration, since the first unitary storage object has reached its size limit (e.g., 1 GB) the first unitary storage object can be transmitted and/or transferred to the cloud storage equipment. The second unitary storage object, since it is not full (e.g., there is still approximately 500 MB free), can await further and subsequent packing with other deemed “small files.” In regard to the awaiting further and subsequent packing with other deemed “small files,” the duration during which archival engine 102 can wait can be based on whether or not there are any other “small files” that need to be packed into secondary unitary storage objects and/or whether a defined duration, as measured by a timer (e.g., countdown timer, count-up timer, system clock, generic system clock, . . . ), has expired.

Archival engine 102, at act 210, contemporaneously with packing small files into unitary storage objects can create/update a manifest structure/stitching object with data representing each “small file” included in the unitary storage objects. Archival engine 102 can use one or more data structure type to represent the contents of each unitary storage object and/or linkages between small files that can have been packed into secondary and/or tertiary unitary storage objects. For instance, in reference to the above example of the first “small file” of 500 MB, the second “small file” of 500 MB, and the third “small file” of 500 MB that have associations between them, the first “small file” and the second “small file” can be packed into a first unitary storage object and the third “small file” can be packed into a second unitary storage object. Archival engine 102 can annotate a first manifest structure/stitching object associated with the first unitary storage object with data associated with the fact that there are associative linkages between the first “small file” and the second “small file” included in the first unitary storage object. Additionally, archival engine 102 can further annotate the first manifest structure/stitching object associated with the first unitary storage object with additional data representing the fact that the first “small file” and the second “small file” that have been incorporated into the first unitary storage object are also associatively tied (e.g., linked) to a third “small file” that has been incorporated into a second unitary storage object. It should be noted that archival engine 102 in the context of the second unitary storage object and its associated second manifest structure/stitching object can note the one or more linkages between the third “small file” incorporated into the second unitary storage object and the first “small file” and second “small file” contained in the first unitary storage object.

In regard to the manifest structure/stitching object this can be structured data in the form of a keyed hash, an array of links, a group of key value pairs, collections of tuples, an m-dimensional table structure, wherein m is an integer greater than 1, an array of arrays, hierarchical tree structures, linked lists, and the like. In some embodiments, the structured data used for purposes of the manifest structure/stitching object can, where practicable, comprise two or more combinations of the example data structures enumerated above.

Archival engine 102, once the manifest structure/stitching object has been updated to reflect the content of the unitary storage object, the unitary storage object can be transmitted/transferred to cloud storage equipment at act 212 of method 200. Having sent the unitary storage object to the cloud storage equipment archival engine 102, at act 214 can wait for an acknowledgement representing acknowledgment data to be returned from the cloud storage equipment. In instances where the acknowledgement data is not returned within a defined period of time, archival engine 102 can attempt to resend the unitary storage object to the cloud storage equipment after a defined or definable back off period. In some embodiments, the defined or definable back off period can be generated using one or more pseudorandom number generator processes in execution, wherein the back off period identified by the one or more pseudorandom number generator process can, for example, be in a range of single digit nanoseconds to approximately multiple digit minutes.

In accordance with certain detailed embodiments, an archival process in execution can be operational on archival engine 102. This archival process, in some embodiments, can be operational as a background process, wherein the archival process is in a state of continuous execution. In some additional embodiments, the archival process can be a background process that exits from a hiatus state and enters an operational state at defined periods of time. For instance, the archival process can be in a hiatus state during business hours (e.g., 08:00 hours to 18:00 hours, Monday to Friday) and can become active in non business hours (e.g., 18:01 to 07:50, Monday to Friday, and all day (e.g., 24 hours) Saturday and Sunday). In some embodiments, the archival process can be active periodically during a 24-hour period. For example, the archival process can become active at the top/beginning of every hour (e.g., the archival process becomes active at 01:00, executes for a tunable duration of time, and at the end of the tunable duration of time the archival process enters into a sleep state until the top/beginning of the next hour).

When the archival process in execution on archival engine 102 emerges out from a hiatus/sleep state can determine whether or not any files have been received that are indicated as being candidates for subsequent archival to storage equipment. In instances, where the archival process determines that there are files that have been indicated as candidates for archival of storage equipment, the archival process can determine whether or not the candidate files exceed a defined size threshold value (e.g., 1 GB). In instances where the candidate file sizes are less than the defined size threshold value, the archival process can include the candidate files to a current unitary storage object, all the while ensuring that inclusion of the candidate files to the current unitary storage object do not exceed the defined size threshold value (e.g., 1 GB). Once the current unitary storage object has reached the defined size threshold value, the archival process can modify/update a manifest structure/stitching object with details associated with each of the files that have been included in the current unitary storage object. At the conclusion of modifying/updating the manifest structure/stitching object, the current unitary storage object can be transferred/transmitted to cloud storage equipment for archival of the current unitary storage object.

In instances where the archival process in execution on archival engine 102 emerges out from a hiatus/sleep state and determines that there exists an earlier created, but partially filled or nearly complete, unitary storage object (e.g., a unitary storage object that was generated prior to the archival process being placed into a state of stasis) comprising files that can have been have been received and included in the earlier unitary storage object in an earlier epoch (e.g., when the archival process was previously active), the archival process can ensure that the manifest structure/stitching object actually reflects the content of the earlier created unitary storage object, and transmit/transfer the earlier created unitary storage object to cloud storage equipment for archival.

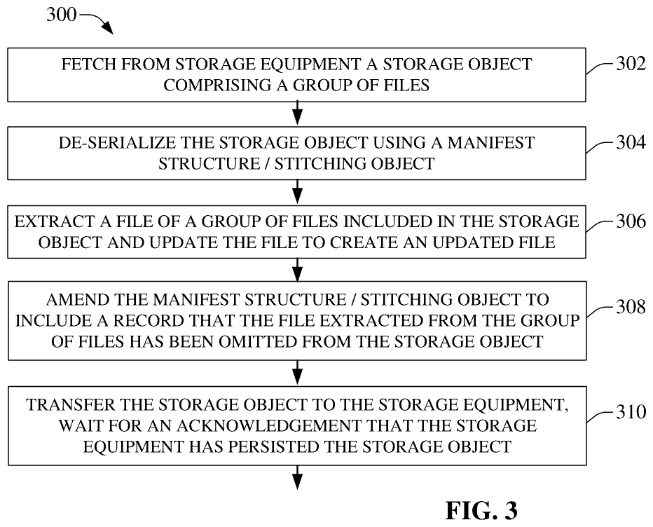

Concerning FIG. 3, a method 300 for optimizing data archival in accordance with various detailed embodiment is detailed, wherein archival engine 102 can effectuate execution of executable instructions detailed in method 300 at act 302. At act 302 archival engine 102 can fetch from storage equipment a storage object (e.g., unitary storage object that had been persisted to the storage equipment) comprising a group of files. The command to fetch the storage object can have been initiated, for example, by an archival process in execution on system 100 and/or by an archival process that can be in execution on the storage equipment.

Archival engine 102 in response to receiving the storage object can, at act 304, de-serialize the storage object using the manifest structure/stitching object to identify one or more files that may need to be updated with newly created user identity data and/or archived to longer retention storage media (e.g., reel-to-reel tape media, optical storage media, WORM storage, and the like). At act 306 archival engine 102 can extract the identified one or more files from the grouping of files that were included in the storage object. Contemporaneously with extracting the identified one or more files from the grouping of files included in the storage object, the extraction process, at act 306, where needed, can modify the one or more files that need updating with newly created user identity data, thereby creating one or more updated file. At this juncture since the one or more files needed to be updated with newly created user identity data to create one or more updated files, these one or more updated files can no longer be considered as candidates for long term retention/archival (e.g., since they have been updated), and as such can be removed from the storage object and the manifest structure/stitching object can be appropriately modified/amended to reflect the fact that the now updated one or more updated files are no longer present in the storage object. These one or more updated files, for example, can be moved to other persistence media not typically associated with archival data and/or long term storage media.

Archival engine 102, at act 308, can amend the manifest structure/stitching object to include a record that one or more files from the grouping of files that were initially included in the storage object have been removed and are now longer present in the storage object. Once archival engine 102 has amended the manifest structure/stitching object to include record that the one or more files are now absent from the storage object, archival engine 102 can proceed to act 310, wherein archival engine 102 can transfer/transmit the storage object to the storage equipment.

It should be noted that the transfer/transmission of the storage object to the storage equipment may be delayed in instances where the storage object is not fully packed with file content. By way of example, if the storage object is less than 50% full, archival engine 102 can postpone transfer/transmittal of the storage object to storage equipment for a defined duration of time until (i) the storage object is fuller, or (ii) the defined duration to time has expired. Also at act 310, archival engine 102, having sent the storage object to storage equipment can await an acknowledgement response from the storage equipment. In instances, where no acknowledgement response is forthcoming from the storage equipment within a tunable time period, archival engine 102 can (i) in response to the expiration of the tunable time period, re-send the storage object to the storage equipment; (ii) set a defined back off period and on expiration of the defined back off period attempt to resend the storage object to the storage equipment; or (iii) determine whether the storage object has already been sent to the storage equipment (e.g., the storage equipment failed to return an acknowledgement response in reply to at least a first attempt to transfer/transmit the storage object to the storage equipment), if so, temporarily persist the storage object to temporary storage (e.g., memory 106 and/or storage 108), define a holding time period, and on the expiration of the defined holding period re-attempt sending the storage object persisted to the temporary storage to the storage equipment.

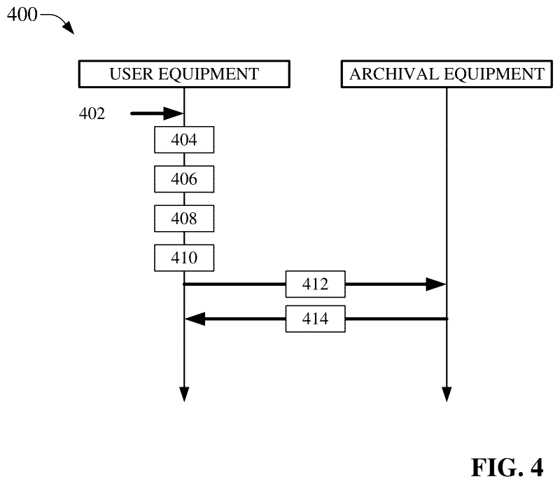

FIG. 4 depicts a time-sequence/flow chart 400 for optimizing data archival in accordance with various embodiments detailed herein. Archival engine 102 can effectuate time-sequence/flow chart 400, wherein at act 402 archival engine 102 can receive a group or collection of files that can have been marked, by an archival process executing on at least one processor 104 in conjunction with archival engine 102, as being candidates for storage/archival to archival equipment. In response to receiving the group or collection of files marked as being candidates for storage/archival to archival equipment, at act 404, archival engine 102 can determine whether or not the sizes of the files included in the collection/grouping of files fall below a defined threshold value (e.g., 1 GB). Further, at this stage archival engine 102 can effectuate orderings or rankings between the sizes of the files included in the collection/grouping of files. By way of example, archival engine 102 can order the files based on a relative size between each of the files in the collection/grouping of files. In some instances, archival engine 102 can facilitate a distribution of the files around, for example: (i) a modal file size; (ii) a mean file size; (iii) an average file size; (iv) median file size; and the like. The modal, mean, average, and/or median file size can be based on past observations that can have been made by archival engine 102 (e.g., using one or more neural network/artificial intelligence process, machine learning process, big dataset technologies, and the like).

At act 406, archival engine 102 can group files that fall below the defined threshold value into one or more associative groupings based at least in part on one or more associations that can exist between the files. For instance, associations between the files can be based on file creation dates, file modification dates, file access dates, dates associated with an IAM role of a user identity that created the file, modified the file, and accessed the file. Associations between file can also be based on security features associated with the files. For instance, files with a defined security level can be associated with one another. Similarly, files can also be associated based on their content. For example, files that comprise coding instructions can be associated with one another, audio files, video files, and/or subtitle files associated with a defined movie can be associated with one another, and the like. Further, files can be classified or categorized based on commonalities in attributes associated with the files. By way of example, files with common retention dates can be grouped together, files with legal retention requirements can form a collection, files associated with various governmental entities can for a grouping, etc.

As has been noted earlier, maintenance of various associations and connectivity between files can be effectuated by one or more graphing structures such as a multi-graph and/or hyper-graph. Nevertheless, as will be appreciated by those skilled in the art, other data structures, such as combinations of hierarchical trees, n-dimensional arrays where n is at least a positive integer greater than 0, tables, lists, linked lists, heaps, stacks, and the like, can be utilized to organize and maintain the various associations and connectivity between files.

Archival engine 102, at act 408, using one or more of the graph structures and/or the other data structures can pack the files into unitary storage units. As has been observed the unitary storage objects detailed in this disclosure can have a defined length (e.g., 1 GB). Thus, files that have been determined to be less than the defined length, that have been organized, sorted, ranked, ordered, for example based on various associations that can exist between the files at issue, can be packed into one or more unitary storage object. Archival engine 102, during the packing process can, as noted earlier, ensure that the 1 GB limit associated with the one or more storage object is maintained and is never exceeded.

Archival engine 102, at act 410, contemporaneously with packing files into unitary storage objects can create/update a manifest structure/stitching object with data representing each file included in the unitary storage objects. Archival engine 102 can use one or more data structure type to represent the contents of each unitary storage object and/or linkages between files that can have been packed into secondary and/or tertiary unitary storage objects. At act 410, archival engine 102 can annotate a first manifest structure/stitching object associated with the first unitary storage object with data associated with the fact that there are associative linkages between a first file and a second file included in the first unitary storage object. Additionally, archival engine 102 can further annotate the first manifest structure/stitching object associated with the first unitary storage object with additional data representing the fact that the first file and the second file that have been incorporated into the first unitary storage object are also associatively linked to a third file that can have been incorporated into a second unitary storage object. It should be noted that archival engine 102 in the context of the second unitary storage object and its associated second manifest structure/stitching object can note the one or more linkages between the third file incorporated into the second unitary storage object and the first file and second file contained in the first unitary storage object.

As noted above, the manifest structure/stitching object can be structured data in the form, for example, of a keyed hash, an array of links, a group of key value pairs, collections of tuples, an m-dimensional table structure, wherein m is an integer greater than 1, an array of arrays, hierarchical tree structures, linked lists, and the like. In some embodiments, the structured data used for purposes of the manifest structure/stitching object can, where practicable, comprise two or more combinations of the example data structures enumerated above.

Archival engine 102, once the manifest structure/stitching object has been updated to reflect the content of the unitary storage object, the unitary storage object can be transmitted/transferred to archive equipment at act 412. Having sent the unitary storage object to the archive equipment archival engine 102, at act 414 can wait for an acknowledgement representing acknowledgment data to be returned from the archive equipment. In instances where the acknowledgement data is not returned within a defined period of time, archival engine 102 can attempt to resend the unitary storage object to the archive equipment after a defined or definable back off period. In some embodiments, the defined or definable back off period can be generated using one or more pseudorandom number generator processes in execution, wherein the back off period identified by the one or more pseudorandom number generator process can, for example, be in a range of single digit nanoseconds to approximately multiple digit minutes.

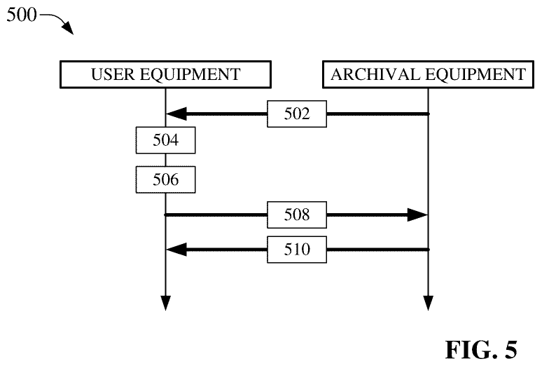

Concerning FIG. 5, a time sequence chart 500 for optimizing data archival in accordance with various detailed embodiment is detailed. Here archival engine 102 can effectuate execution of executable instructions associated with time sequence chart 500. At act 502, archival engine 102 can fetch from archival equipment a storage object (e.g., unitary storage object that had been persisted in the past to the archival equipment) comprising a group of files. The command to fetch the storage object, at act 502, can have been initiated by an archival process in execution on system 100 and/or by an archival process that can be in execution on the archival equipment.

Archival engine 102 in response to receiving the storage object can, at act 504, de-serialize the storage object using the manifest structure/stitching object to identify one or more files that may need to be updated with newly created user identity data and/or archived to longer retention storage media (e.g., reel-to-reel tape media, optical storage media, WORM storage, and the like). At act 506 archival engine 102 can extract the identified one or more files from the grouping of files that were included in the storage object. Contemporaneously with extracting the identified one or more files from the grouping of files included in the storage object, the extraction process, at act 506, where needed, can modify the one or more files that need updating with newly created user identity data, thereby creating one or more updated file.

As has been noted earlier, since the one or more updated file has been amended with new user identity data thereby creating the one or more updated file, the one or more updated file can technically no longer be classified as being a candidate for long term retention/archival, and as such the one or more updated file can be removed from the storage object and the manifest structure/stitching object can be updated to reflect that the one or more updated file is no longer part of, and/or associated with, the storage object. The one or more updated file can thereafter be designated as being a “normal file” and can be stored to a more active day-to-day primary storage media.

Archival engine 102, at act 508, can amend the manifest structure/stitching object to include a record that the one or more updated file is no longer to be classified as being a candidate for long term retention/archival and is now being omitted (e.g., not included) from the storage object. Once archival engine 102 has amended the manifest structure/stitching object to note that the storage object does not include the one or more files that have now become updated files and therefore to be excluded from the storage object, archival engine 102 can proceed to act 510, wherein archival engine 102 can transfer/transmit the storage object to the archival equipment. It should be noted that the transfer/transmission of the storage object to the archival equipment may be delayed in instances where the storage object is not fully packed with file content. By way of example, if the storage object is less than a defined value (e.g., 75%) full, archival engine 102 can postpone transfer/transmittal of the storage object to archival equipment for a defined duration of time until (i) the storage object is more full, or (ii) the defined duration to time has expired. Also at act 510, archival engine 102, having sent the storage object to archival equipment can await an acknowledgement response from the archival equipment. In instances, where no acknowledgement response is forthcoming from the archival equipment within a tunable time period, archival engine 102 can (i) in response to the expiration of the tunable time period, re-send the storage object to the archival equipment; (ii) set a defined back off period and on expiration of the defined back off period attempt to resend the storage object to the archival equipment; or (iii) determine whether the storage object has already been sent to the archival equipment (e.g., the archival equipment failed to return an acknowledgement response in reply to at least a first attempt to transfer/transmit the storage object to the archival equipment), if so, temporarily persist the storage object to temporary storage (e.g., memory 106 and/or storage 108), define a holding time period, and on the expiration of the defined holding period re-attempt sending the storage object persisted to the temporary storage to the archival equipment.

FIG. 6 depicts an illustrative storage object 600 in accordance with many embodiments set forth is this description. As illustrated storage object 600 can comprise a stitching object/manifest structure 602, a small file 604, and wasted space 606. In this example, the storage object 600 is of a defined size (e.g., 1 GB), the stitching object/manifest structure 602 can comprise data representative of the small file 604 that is less than the defined size, as well as information regarding the wasted space 606 (e.g., the quantity of space that has been wasted/not used. The size of the small file 604, in this example, can be extremely small and can be reflective to the situation that currently exists where small files are transferred/transmitted to cloud storage equipment with considering whether or not the storage object (e.g. storage object SJT00) is as full as it can be (e.g., carry a group of files the combined file sizes of the group approaching the defined size of the storage object (e.g., 1 GB).

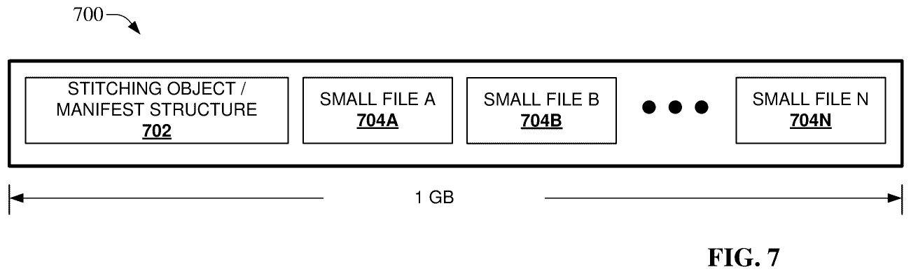

FIG. 7 depicts another example storage object 700 that can comprise multiple small files (e.g., small file A 704A, small file B 704B, . . . , small file N 704N, wherein A . . . N are positive integers greater than 0). In this example illustration, storage object 700 can be as full as it can be with the payload of small files and stitching object/manifest structure approaching the defined storage object defined size of 1 GB.

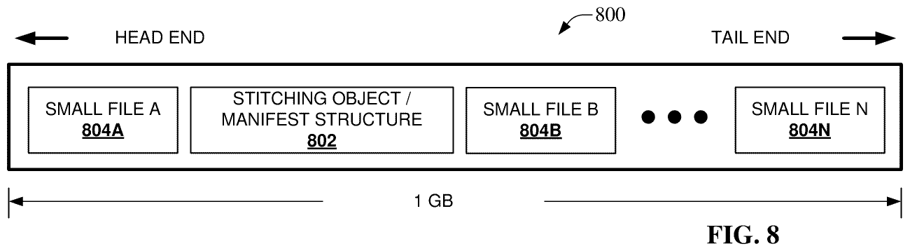

FIG. 8 depicts another example storage object 800 in accordance with various embodiments set forth in this disclosure. In this illustration attention should be paid to the positioning of stitching object/manifest structure 802. Typically it is normal practice to locate the stitching object/manifest structure at the head end of the storage object 800 (see e.g., sample storage object 600 illustrated in FIG. 6 and sample storage object 700 in FIG. 7), wherein the head end of each of storage object 600 and 700 are depicted as carrying their respective stitching object/manifest structures (e.g., stitching object/manifest structure 602 and stitching object/manifest structure 702) at the head end. This need not be the case in all instances and/or embodiments, as the stitching object/manifest structure 802 can be located at a randomly defined location amongst the small file A 804A . . . small file N 804N. Moreover, while the stitching object/manifest structure 802 is illustrated as being a monolithic block structure, this too need not be the general case, as in certain embodiments, the stitching object/manifest structure 802 can be broken down (split) into multiple fragments representing the stitching object/manifest structure 802, wherein the multiple fragments can be interspersed throughout the storage object 800 and/or in between the small files A 804A . . . small files N 804N.

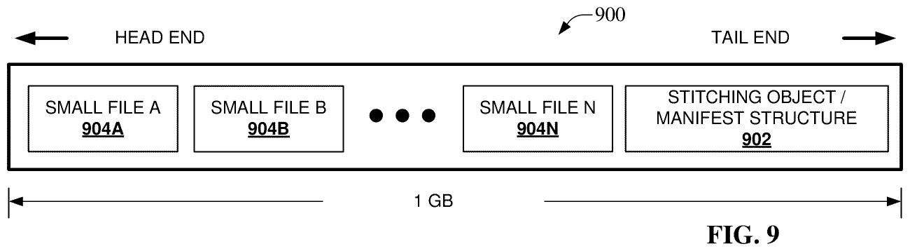

FIG. 9 depicts further example storage object 900 representation in accordance with various embodiments set forth in this disclosure. In this illustration attention should be paid to the positioning of stitching object/manifest structure 902. As has been noted above, it is typical practice to locate the stitching object/manifest structure at the head end of the storage object 900. In this depiction of example storage object 900 the stitching object/manifest structure 902 has been located at the tail endo the storage object 900.

It will be appreciated by those skilled in the art that the preceding examples and embodiments are exemplary and not limiting to the scope of the present disclosure. It shall also be noted that elements of any claims may be arranged differently including having multiple dependencies, configurations, and combinations.

In view of the example embodiment(s) described above, the foregoing example method(s) or process(es) can be implemented in accordance with the disclosed subject matter. It is to be appreciated with regard to the described and detailed methods, flowcharts, and/or illustrative time sequence charts and for purposes of simplicity of explanation, a example method disclosed herein is presented and described as a series of acts; however, it is to be understood and appreciated that the disclosure is not limited by the order of acts, as some acts may occur in different orders and/or concurrently with other acts from that shown and described herein. For example, one or more example methods disclosed herein could alternatively be represented as a series of interrelated states or events, such as in a state diagram. Moreover, interaction diagram(s) may represent methods in accordance with the disclosed subject matter when disparate entities enact disparate portions of the methods. Furthermore, not all illustrated acts may be required to implement a described example method in accordance with the subject specification. Further yet, the disclosed example method can be implemented in combination with one or more other methods, to accomplish one or more aspects herein described. It should be further appreciated that the example methods disclosed throughout the subject specification are capable of being stored on an article of manufacture (e.g., a computer-readable medium) to allow transporting and transferring such methods to computers for execution, and thus implementation, by a processor or for storage in a memory.

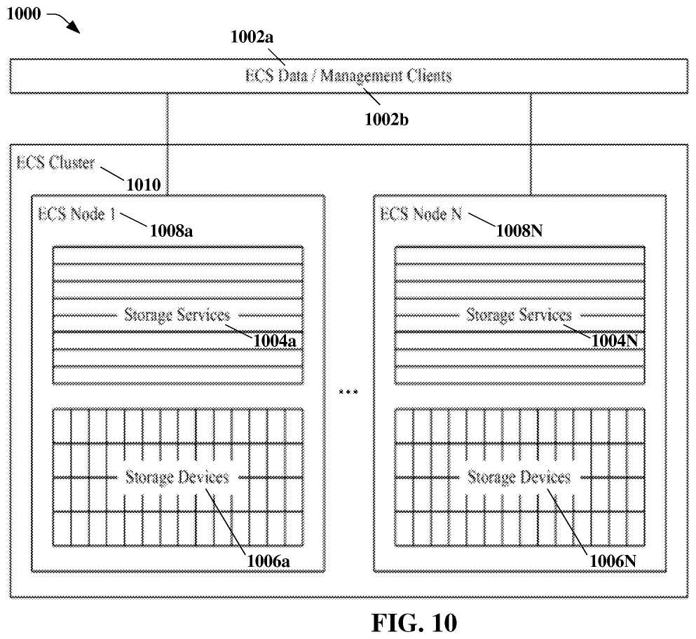

In the following, FIG. 10 describes an example non-limiting cloud storage system in the non-limiting context of an ECS storage system, but for the avoidance of doubt, the subject embodiments can apply to any storage platform. For instance, in this regard, FIG. 10 illustrates an ECS storage system 1000 comprising a cloud-based object storage appliance in which corresponding storage control software comprising, e.g., ECS data client(s) 1002a, ECS management client(s) 1002b, storage service(s) 1004a . . . 1004N, etc. and storage devices 1006a . . . 1006N (e.g., storage media, such as physical magnetic disk media, etc. of respective ECS nodes of ECS cluster 1010) are combined as an integrated system with no access to the storage media other than through the ECS storage system 1000.

In this regard, ECS cluster 1010 comprises multiple nodes 1008a 1008N, storage nodes, ECS nodes, etc. Each node is associated with storage devices 1006a . . . 1006N, e.g., hard drives, physical disk drives, storage media, etc. In embodiment(s), ECS node 1008a, or any ECS node, executing on a hardware appliance can be communicatively coupled, connected, cabled to, etc., e.g., 15 to 120 storage devices. Further, each ECS node can execute one or more services for performing data storage operations described herein.

For instance, the ECS storage system 1000 can be an append-only virtual storage platform that protects content from being erased or overwritten for a specified retention period. In particular, the ECS storage system 1000 does not employ traditional data protection schemes like mirroring or parity protection. Instead, the ECS storage system 1000 utilizes erasure coding for data protection, wherein data, a portion of the data, e.g., a data chunk, is broken into fragments, and expanded and encoded with redundant data pieces and then stored across a set of different locations or storage media, e.g., across different storage nodes.

The ECS storage system 1000 can support storage, manipulation, and/or analysis of unstructured data on a massive scale on commodity hardware. As an example, the ECS storage system 1000 can support mobile, cloud, big data, and/or social networking applications. In another example, the ECS storage system 1000 can be deployed as a turnkey storage appliance, or as a software product that can be installed on a set of qualified commodity servers and disks, e.g., within a node, data storage node, etc. of a cluster, data storage cluster, etc. In this regard, the ECS storage system 1000 can comprise a cloud platform that comprises at least the following features: (i) lower cost than public clouds; (ii) unmatched combination of storage efficiency and data access; (iii) anywhere read/write access with strong consistency that simplifies application development; (iv) no single point of failure to increase availability and performance; (v) universal accessibility that eliminates storage silos and inefficient extract, transform, load (ETL)/data movement processes; etc.

In embodiment(s), the cloud-based data storage system can comprise an object storage system, e.g., a file system comprising, but not limited to comprising, a Dell EMC® Isilon file storage system. As an example, a storage engine can write all object-related data, e.g., user data, metadata, object location data, etc. to logical containers of contiguous disk space, e.g., such containers comprising a group of blocks of fixed size (e.g., 128 MB) known as chunks. Data is stored in the chunks and the chunks can be shared, e.g., one chunk can comprise data fragments of different user objects. Chunk content is modified in append-only mode, e.g., such content being protected from being erased or overwritten for a specified retention period. When a chunk becomes full enough, it is sealed, closed, etc. In this regard, content of a sealed, closed, etc. chunk is immutable, e.g., read-only, and after the chunk is closed, the storage engine performs erasure-coding on the chunk.

Reference throughout this specification to “one embodiment,” or “an embodiment,” means that a particular feature, structure, or characteristic described in connection with the embodiment is included in at least one embodiment. Thus, the appearances of the phrase “in one embodiment,” or “in an embodiment,” in various places throughout this specification are not necessarily all referring to the same embodiment. Furthermore, the particular features, structures, or characteristics may be combined in any suitable manner in one or more embodiments.

Furthermore, to the extent that the terms “includes,” “has,” “contains,” and other similar words are used in either the detailed description or the appended claims, such terms are intended to be inclusive-in a manner similar to the term “comprising” as an open transition word-without precluding any additional or other elements. Moreover, the term “or” is intended to mean an inclusive “or” rather than an exclusive “or”. That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims should generally be construed to mean “one or more” unless specified otherwise or clear from context to be directed to a singular form.

As utilized herein, the terms “logic,” “logical,” “logically,” and the like are intended to refer to any information having the form of instruction signals and/or data that may be applied to direct the operation of a processor. Logic may be formed from signals stored in a device memory. Software is one example of such logic. Logic may also be comprised by digital and/or analog hardware circuits, for example, hardware circuits comprising logical AND, OR, XOR, NAND, NOR, and other logical operations. Logic may be formed from combinations of software and hardware. On a network, logic may be programmed on a server, or a complex of servers. A particular logic unit is not limited to a single logical location on the network.

As utilized herein, terms “component,” “system,” “engine”, and the like are intended to refer to a computer-related entity, hardware, software (e.g., in execution), and / or firmware. For example, a component can be a processor, a process running on a processor, an object, an executable, a program, a storage device, and/or a computer. By way of illustration, an application running on a server, client, etc. and the server, client, etc. can be a component. One or more components can reside within a process, and a component can be localized on one computer and/or distributed between two or more computers.

Further, components can execute from various computer readable media having various data structures stored thereon. The components can communicate via local and/or remote processes such as in accordance with a signal having one or more data packets (e.g., data from one component interacting with another component in a local system, distributed system, and/or across a network, e.g., the Internet, with other systems via the signal).

As another example, a component can be an apparatus with specific functionality provided by mechanical parts operated by electric or electronic circuitry; the electric or electronic circuitry can be operated by a software application or a firmware application executed by one or more processors; the one or more processors can be internal or external to the apparatus and can execute at least a part of the software or firmware application. In yet another example, a component can be an apparatus that provides specific functionality through electronic components without mechanical parts; the electronic components can comprise one or more processors therein to execute software and/or firmware that confer(s), at least in part, the functionality of the electronic components.

Aspects of systems, apparatus, and processes explained herein can constitute machine-executable instructions embodied within a machine, e.g., embodied in a computer readable medium (or media) associated with the machine. Such instructions, when executed by the machine, can cause the machine to perform the operations described. Additionally, the systems, processes, process blocks, etc. can be embodied within hardware, such as an application specific integrated circuit (ASIC) or the like. Moreover, the order in which some or all of the process blocks appear in each process should not be deemed limiting. Rather, it should be understood by a person of ordinary skill in the art having the benefit of the instant disclosure that some of the process blocks can be executed in a variety of orders not illustrated.

Furthermore, the word “exemplary” and/or “demonstrative” is used herein to mean serving as an example, instance, or illustration. For the avoidance of doubt, the subject matter disclosed herein is not limited by such examples. In addition, any aspect or design described herein as “exemplary” and/or “demonstrative” is not necessarily to be construed as preferred or advantageous over other aspects or designs, nor is it meant to preclude equivalent exemplary structures and techniques known to those of ordinary skill in the art having the benefit of the instant disclosure.

The disclosed subject matter can be implemented as a method, apparatus, or article of manufacture using standard programming and/or engineering techniques to produce software, firmware, hardware, or any combination thereof to control a computer to implement the disclosed subject matter. The term “article of manufacture” as used herein is intended to encompass a computer program accessible from any computer-readable device, computer-readable carrier, or computer-readable media. For example, computer-readable media can comprise, but are not limited to: random access memory (RAM); read only memory (ROM); electrically erasable programmable read only memory (EEPROM); flash memory or other memory technology (e.g., card, stick, key drive, thumb drive, smart card); solid state drive (SSD) or other solid-state storage technology; optical disk storage (e.g., compact disk (CD) read only memory (CD ROM), digital video/versatile disk (DVD), Blu-ray disc); cloud-based (e.g., Internet based) storage; magnetic storage (e.g., magnetic cassettes, magnetic tape, magnetic disk storage or other magnetic storage devices); a virtual device that emulates a storage device and/or any of the above computer-readable media; or other tangible and/or non-transitory media which can be used to store desired information. In this regard, the terms “tangible” or “non-transitory” herein as applied to storage, memory, or computer-readable media, are to be understood to exclude only propagating transitory signals per se as modifiers and do not relinquish rights to all standard storage, memory or computer-readable media that are not only propagating transitory signals per se.

Artificial intelligence based systems, e.g., utilizing explicitly and/or implicitly trained classifiers, can be employed in connection with performing inference and/or probabilistic determinations and/or statistical-based determinations as in accordance with one or more aspects of the disclosed subject matter as described herein. For example, an artificial intelligence system can be used to determine probabilistic likelihoods that code paths utilize operating system synchronization mechanism, as described herein.

A classifier can be a function that maps an input attribute vector, x=(x1, x2, x3, x4, . . . , xn), to a confidence that the input belongs to a class, that is, f(x)=confidence (class). Such classification can employ a probabilistic and/or statistical-based analysis (e.g., factoring into the analysis utilities and costs) to infer an action that a user desires to be automatically performed. In the case of communication systems, for example, attributes can be information received from access points, servers, components of a wireless communication network, etc., and the classes can be categories or areas of interest (e.g., levels of priorities). A support vector machine is an example of a classifier that can be employed. The support vector machine operates by finding a hypersurface in the space of possible inputs, which the hypersurface attempts to split the triggering criteria from the non-triggering events. Intuitively, this makes the classification correct for testing data that is near, but not identical to training data. Other directed and undirected model classification approaches include, e.g., naïve Bayes, Bayesian networks, decision trees, neural networks, fuzzy logic models, and probabilistic classification models providing different patterns of independence can be employed. Classification as used herein can also be inclusive of statistical regression that is utilized to develop models of priority.

In accordance with various aspects of the subject specification, artificial intelligence based systems, components, etc. can employ classifiers that are explicitly trained, e.g., via a generic training data, etc. as well as implicitly trained, e.g., via observing characteristics of communication equipment, e.g., a server, etc., receiving reports from such communication equipment, receiving operator preferences, receiving historical information, receiving extrinsic information, etc. For example, support vector machines can be configured via a learning or training phase within a classifier constructor and feature selection module. Thus, the classifier(s) can be used by an artificial intelligence system to automatically learn and perform a number of functions.

As used herein, the term “infer” or “inference” refers generally to the process of reasoning about, or inferring states of, the system, environment, user, and/or intent from a set of observations as captured via events and/or data. Captured data and events can include user data, device data, environment data, data from sensors, sensor data, application data, implicit data, explicit data, etc. Inference can be employed to identify a specific context or action, or can generate a probability distribution over states of interest based on a consideration of data and events, for example.

Inference can also refer to techniques employed for composing higher-level events from a set of events and/or data. Such inference results in the construction of new events or actions from a set of observed events and/or stored event data, whether the events are correlated in close temporal proximity, and whether the events and data come from one or several event and data sources. Various classification schemes and/or systems (e.g., support vector machines, neural networks, expert systems, Bayesian belief networks, fuzzy logic, and data fusion engines) can be employed in connection with performing automatic and/or inferred action in connection with the disclosed subject matter.

As it is employed in the subject specification, the term “processor” can refer to substantially any computing processing unit or device comprising, but not limited to comprising, single-core processors; single-processors with software multithread execution capability; multi-core processors; multi-core processors with software multithread execution capability; multi-core processors with hardware multithread technology; parallel platforms; and parallel platforms with distributed shared memory. Additionally, a processor can refer to an integrated circuit, an application specific integrated circuit (ASIC), a digital signal processor (DSP), a field programmable gate array (FPGA), a programmable logic controller (PLC), a complex programmable logic device (CPLD), a discrete gate or transistor logic, discrete hardware components, or any combination thereof designed to perform the functions and/or processes described herein. Processors can exploit nano-scale architectures such as, but not limited to, molecular and quantum-dot based transistors, switches and gates, in order to optimize space usage or enhance performance of mobile devices. A processor may also be implemented as a combination of computing processing units.

In the subject specification, terms such as “store,” “data store,” “data storage,” “database,” “storage medium,” “socket”, and substantially any other information storage component relevant to operation and functionality of a system, component, and/or process, can refer to “memory components,” or entities embodied in a “memory,” or components comprising the memory. It will be appreciated that the memory components described herein can be either volatile memory or nonvolatile memory, or can comprise both volatile and nonvolatile memory.

By way of illustration, and not limitation, nonvolatile memory, for example, can be included in a data storage cluster, non-volatile memory 1122, disk storage 1124, and/or memory storage 1146, further description of which is below. For instance, nonvolatile memory can be included in read only memory (ROM), programmable ROM (PROM), electrically programmable ROM (EPROM), electrically erasable ROM (EEPROM), or flash memory. Volatile memory 1120 can comprise random access memory (RAM), which acts as external cache memory. By way of illustration and not limitation, RAM is available in many forms such as synchronous RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), and direct Rambus RAM (DRRAM). Additionally, the disclosed memory components of systems or methods herein are intended to comprise, without being limited to comprising, these and any other suitable types of memory.

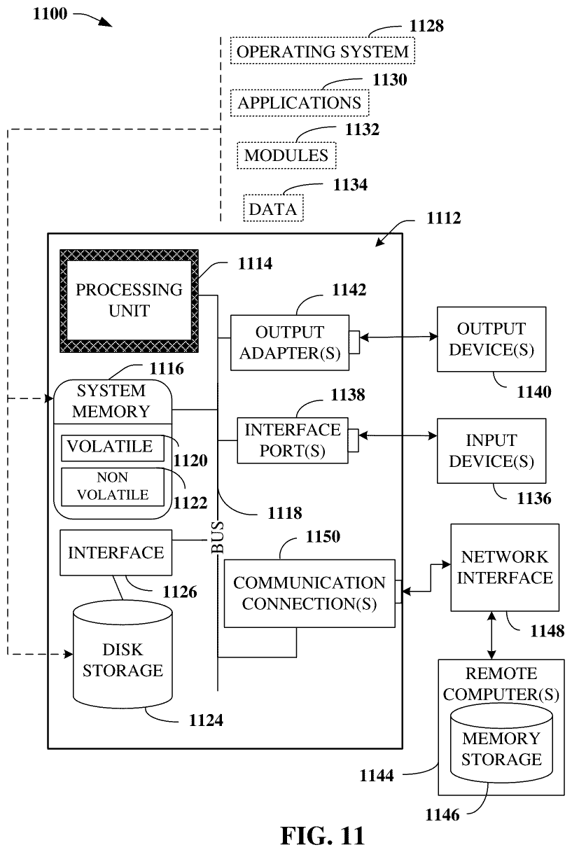

In order to provide a context for the various aspects of the disclosed subject matter, FIG. 11, and the following discussion, are intended to provide a brief, general description of a suitable environment in which the various aspects of the disclosed subject matter can be implemented. While the subject matter has been described above in the general context of computer-executable instructions of a computer program that runs on a computer and/or computers, those skilled in the art will recognize that various embodiments disclosed herein can be implemented in combination with other program modules. Generally, program modules comprise routines, programs, components, data structures, etc. that perform particular tasks and/or implement particular abstract data types.

Moreover, those skilled in the art will appreciate that the inventive systems can be practiced with other computer system configurations, comprising single-processor or multiprocessor computer systems, computing devices, mini-computing devices, mainframe computers, as well as personal computers, hand-held computing devices (e.g., PDA, phone, watch), microprocessor-based or programmable consumer or industrial electronics, and the like. The illustrated aspects can also be practiced in distributed computing environments where tasks are performed by remote processing devices that are linked through a communication network; however, some if not all aspects of the subject disclosure can be practiced on stand-alone computers. In a distributed computing environment, program modules can be located in both local and remote memory storage devices.

FIG. 11, a block diagram of a computing system 1100, e.g., system 700, operable to execute the disclosed example embodiments, is illustrated, in accordance with an embodiment. Computer 1112 comprises a processing unit 1114, a system memory 1116, and a system bus 1118. System bus 1118 couples system components comprising, but not limited to, system memory 1116 to processing unit 1114. Processing unit 1114 can be any of various available processors. Dual microprocessors and other multiprocessor architectures can also be employed as processing unit 1114.

System bus 1118 can be any of several types of bus structure(s) comprising a memory bus or a memory controller, a peripheral bus or an external bus, and/or a local bus using any variety of available bus architectures comprising, but not limited to, industrial standard architecture (ISA), micro-channel architecture (MSA), extended ISA (EISA), intelligent drive electronics (IDE), VESA local bus (VLB), peripheral component interconnect (PCI), card bus, universal serial bus (USB), advanced graphics port (AGP), personal computer memory card international association bus (PCMCIA), Firewire (IEEE 1394), small computer systems interface (SCSI), and/or controller area network (CAN) bus used in vehicles.

System memory 1116 comprises volatile memory 1120 and nonvolatile memory 1122. A basic input/output system (BIOS), containing routines to transfer information between elements within computer 1112, such as during start-up, can be stored in nonvolatile memory 1122. By way of illustration, and not limitation, nonvolatile memory 1122 can comprise ROM, PROM, EPROM, EEPROM, or flash memory. Volatile memory 1120 comprises RAM, which acts as external cache memory. By way of illustration and not limitation, RAM is available in many forms such as SRAM, dynamic RAM (DRAM), synchronous DRAM (SDRAM), double data rate SDRAM (DDR SDRAM), enhanced SDRAM (ESDRAM), Synchlink DRAM (SLDRAM), Rambus direct RAM (RDRAM), direct Rambus dynamic RAM (DRDRAM), and Rambus dynamic Ram (RDRAM).

Computer 1112 also comprises removable/non-removable, volatile/non-volatile computer storage media. FIG. 11 illustrates, for example, disk storage 1124. Disk storage 1124 comprises, but is not limited to, devices like a magnetic disk drive, floppy disk drive, tape drive, Jaz drive, Zip drive, LS-100 drive, flash memory card, or memory stick. In addition, disk storage 1124 can comprise storage media separately or in combination with other storage media comprising, but not limited to, an optical disk drive such as a compact disk ROM device (CD-ROM), CD recordable drive (CD-R Drive), CD rewritable drive (CD-RW Drive) or a digital versatile disk ROM drive (DVD-ROM). To facilitate connection of the disk storage devices 1124 to system bus 1118, a removable or non-removable interface is typically used, such as interface 1126.

It is to be appreciated that FIG. 11 describes software that acts as an intermediary between users and computer resources described in suitable operating environment 1100. Such software comprises an operating system 1128. Operating system 1128, which can be stored on disk storage 1124, acts to control and allocate resources of computer system 1112. System applications 1130 take advantage of the management of resources by operating system 1128 through program modules 1132 and program data 1134 stored either in system memory 1116 or on disk storage 1124. It is to be appreciated that the disclosed subject matter can be implemented with various operating systems or combinations of operating systems.

A user can enter commands or information into computer 1112 through input device(s) 1136. Input devices 1136 comprise, but are not limited to, a pointing device such as a mouse, trackball, stylus, touch pad, keyboard, microphone, joystick, game pad, satellite dish, scanner, TV tuner card, digital camera, digital video camera, web camera, cellular phone, user equipment, smartphone, and the like. These and other input devices connect to processing unit 1114 through system bus 1118 via interface port(s) 1138. Interface port(s) 1138 comprise, for example, a serial port, a parallel port, a game port, a universal serial bus (USB), a wireless based port, e.g., Wi-Fi, Bluetooth, etc. Output device(s) 1140 use some of the same type of ports as input device(s) 1136.

Thus, for example, a USB port can be used to provide input to computer 1112 and to output information from computer 1112 to an output device 1140. Output adapter 1142 is provided to illustrate that there are some output devices 1140, like display devices, light projection devices, monitors, speakers, and printers, among other output devices 1140, which use special adapters. Output adapters 1142 comprise, by way of illustration and not limitation, video and sound devices, cards, etc. that provide means of connection between output device 1140 and system bus 1118. It should be noted that other devices and/or systems of devices provide both input and output capabilities such as remote computer(s) 1144.

Computer 1112 can operate in a networked environment using logical connections to one or more remote computers, such as remote computer(s) 1144. Remote computer(s) 1144 can be a personal computer, a server, a router, a network PC, a workstation, a microprocessor based appliance, a peer device, or other common network node and the like, and typically comprises many or all of the elements described relative to computer 1112.

For purposes of brevity, only a memory storage device 1146 is illustrated with remote computer(s) 1144. Remote computer(s) 1144 is logically connected to computer 1112 through a network interface 1148 and then physically and/or wirelessly connected via communication connection 1150. Network interface 1148 encompasses wire and/or wireless communication networks such as local-area networks (LAN) and wide-area networks (WAN). LAN technologies comprise fiber distributed data interface (FDDI), copper distributed data interface (CDDI), Ethernet, token ring and the like. WAN technologies comprise, but are not limited to, point-to-point links, circuit switching networks like integrated services digital networks (ISDN) and variations thereon, packet switching networks, and digital subscriber lines (DSL).

Communication connection(s) 1150 refer(s) to hardware/software employed to connect network interface 1148 to bus 1118. While communication connection 1150 is shown for illustrative clarity inside computer 1112, it can also be external to computer 1112. The hardware/software for connection to network interface 1148 can comprise, for example, internal and external technologies such as modems, comprising regular telephone grade modems, cable modems and DSL modems, wireless modems, ISDN adapters, and Ethernet cards.

The computer 1112 can operate in a networked environment using logical connections via wired and/or wireless communications to one or more remote computers, cellular based devices, user equipment, smartphones, or other computing devices, such as workstations, server computers, routers, personal computers, portable computers, microprocessor-based entertainment appliances, peer devices or other common network nodes, etc. The computer 1112 can connect to other devices/networks by way of antenna, port, network interface adaptor, wireless access point, modem, and/or the like.

The computer 1112 is operable to communicate with any wireless devices or entities operatively disposed in wireless communication, e.g., a printer, scanner, desktop and/or portable computer, portable data assistant, communications satellite, user equipment, cellular base device, smartphone, any piece of equipment or location associated with a wirelessly detectable tag (e.g., scanner, a kiosk, news stand, restroom), and telephone. This comprises at least Wi-Fi and Bluetooth wireless technologies. Thus, the communication can be a predefined structure as with a conventional network or simply an ad hoc communication between at least two devices.

Wi-Fi allows connection to the Internet from a desired location (e.g., a vehicle, couch at home, a bed in a hotel room, or a conference room at work, etc.) without wires. Wi-Fi is a wireless technology similar to that used in a cell phone that enables such devices, e.g., mobile phones, computers, etc., to send and receive data indoors and out, anywhere within the range of a base station. Wi-Fi networks use radio technologies called IEEE 802.11 (a, b, g, etc.) to provide secure, reliable, fast wireless connectivity. A Wi-Fi network can be used to connect communication devices (e.g., mobile phones, computers, etc.) to each other, to the Internet, and to wired networks (which use IEEE 802.3 or Ethernet). Wi-Fi networks operate in the unlicensed 2.4 and 5 GHz radio bands, at a 10 Mbps (802.11a) or 54 Mbps (802.11b) data rate, for example, or with products that contain both bands (dual band), so the networks can provide real-world performance similar to the basic 10BaseT wired Ethernet networks used in many offices.

The above description of illustrated embodiments of the subject disclosure, comprising what is described in the Abstract, is not intended to be exhaustive or to limit the disclosed embodiments to the precise forms disclosed. While specific embodiments and examples are described herein for illustrative purposes, various modifications are possible that are considered within the scope of such embodiments and examples, as those skilled in the relevant art can recognize.

In this regard, while the disclosed subject matter has been described in connection with various embodiments and corresponding Figures, where applicable, it is to be understood that other similar embodiments can be used or modifications and additions can be made to the described embodiments for performing the same, similar, alternative, or substitute function of the disclosed subject matter without deviating there from. Therefore, the disclosed subject matter should not be limited to any single embodiment described herein, but rather should be construed in breadth and scope in accordance with the appended claims below.

1. Archival equipment, comprising:
at least one processor; and
at least one memory that stores executable instructions that, when executed by the at least one processor, facilitate performance of operations, comprising:
obtaining a group of files that has been indicated as being a candidate for storage to cloud storage equipment;
determining whether a file in the group of files has a file size that is less than a defined file size threshold value;
in response to the determining indicating that the file size is less than the defined file size threshold value, grouping the file into one or more associative groups based on one or more associations that exist between the file and each other file in the group of files, wherein the grouping of the file comprises building a multi-graph structure comprising a group of nodes and a group of arcs, wherein a first node of the group of nodes is connected to a second node of the group of nodes by an arc of the group of arcs that indicates associations with the file and the each other file, and wherein the one or more associations between the file and the each other file are based on associative linkages comprising a collection of commonalities representing at least two of a commonality of ownership, a commonality of time of creation, a commonality of time of modification, a commonality of time of access, a commonality of defined archival time period, or a commonality of governmentally defined legal retention period;
based on the one or more associative groups, packing the file into a storage object of a defined length;
in response to the packing of the file into the storage object, modifying a stitching object with stitching data representing the file placed into the storage object to be a modified stitching object; and
transferring, via a wired or wireless network topology, the modified stitching object to the cloud storage equipment.

2. The archival equipment of claim 1, wherein the operations further comprise monitoring the packing of the file into the storage object to ensure that the defined length of the storage object is not exceeded.

3. The archival equipment of claim 1, wherein the file is a first file, wherein the operations further comprise using a data structure to maintain one or more associative linkages, of the associative linkages, between the first file and a second file that are included in the storage object, and wherein the one or more associative linkages represent associations between the first file and the second file.

4. The archival equipment of claim 1, wherein the file is a first file and the storage object is a first storage object, wherein the operations further comprise using a data structure to maintain one or more associative linkages, of the associative linkages, between the first file included in the first storage object and a second file that is included in a second storage object, and wherein the one or more associative linkages represent associations between the first file and the second file.

5. The archival equipment of claim 1, wherein the stitching object is a data structure that maintains attribute data associated with the file that is packed into the storage object.

6. The archival equipment of claim 1, wherein, in response to the determining indicating that the file size exceeds the defined file size threshold value, fragmenting and grouping the file into the one or more associative groups based on the one or more associations that exist between the file and the each other file in the group of files.

7. The archival equipment of claim 6, wherein the operations further comprise packing the file into the storage object of the defined length.

8. The archival equipment of claim 6, wherein the storage object is a first storage object and the file is a first file, wherein the operations further comprise using a data structure to maintain one or more associative linkages, of the associative linkages, between the first file included in the first storage object and a second file that is included in a second storage object, and wherein the one or more associative linkages represent associations between the first file and the second file.

9. A method, comprising:
fetching, from storage equipment by equipment comprising one or more processors, a storage object comprising a group of files;
based on using a manifest structure associated and included with the storage object, de-serializing, by the equipment, the storage object to extract a file of the group of files;
creating, by the equipment based on the file, an updated file comprising old data representative of a previous version of the file and new data representative of a current version of the file newer than the previous version;
amending, by the equipment, the manifest structure to include a record indicating that the group of files does not comprise the file of the group of files that was used to create the updated file;
re-serializing, by the equipment, the storage object to comprise the group of files exclusive of the file of the group of files that was used to create the updated file, resulting in a re-serialized storage object, wherein the re-serializing comprises generating a graph structure comprising a group of vertices and a group of edges, wherein a first vertex of the group of vertices is connected to a second vertex of the group of vertices by an edge of the group of edges that indicates associations with the file and the group of files, and wherein associations between the file and the group of files are based on associative linkages comprising commonalities representing at least two commonalities from a commonality of ownership, a commonality of time of creation, a commonality of time of modification, a commonality of time of access, a commonality of defined archival time period, or a commonality of governmentally defined legal retention period; and
transmitting, by the equipment, via a wireless network communication infrastructure, the re-serialized storage object to the storage equipment.

10. The method of claim 9, further comprising, updating, by the equipment, associative links between the group of alternative files and other files included in the storage object.

11. The method of claim 9, wherein the storage object is a first storage object, and further comprising, in response to the determining indicating that the group of alternative files exceeds the defined length associated with the first storage object, packing, by the equipment, the group of alternative files into a second storage object.

12. The method of claim 11, wherein the manifest structure is a first manifest structure, and further comprising updating, by the equipment, the first manifest structure to indicate that the group of alternative files has been included in the second storage object.

13. The method of claim 12, further comprising updating, by the equipment, a second manifest structure associated with the second storage object to indicate that the group of alternative files has been included in the second storage object.

14. The method of claim 13, further comprising updating, by the equipment, the first manifest structure and second manifest structure with associative linkage data representing that the group of alternative files is located in the second storage object and the group of files is situated in the first storage object.

15. A non-transitory machine-readable medium, comprising executable instructions that, when executed by a network device comprising at least one processor, facilitate performance of operations, comprising:
retrieving, from storage equipment, a storage object comprising a group of files;
based on using a manifest structure associated with, and included at, a head end the storage object, de-serializing the storage object to extract a file of the group of files, wherein the de-serializing comprises generating a hyper-graph structure comprising a group of nodes and a group of arcs, wherein a first node of the group of nodes is connected to a second node of the group of nodes by an arc of the group of arcs that indicates associations between the file and the group of files, and wherein the associations between the file and the group of files are based on associative linkages comprising a collection of commonalities representing at least two of a commonality of ownership, time of creation, time of modification, time of access, defined archival time period, or governmentally defined legal retention period;
creating an updated file comprising original data and updated data;
changing the manifest structure to include a record indicating that the file of the group of files used to create the updated file has been removed from the group of files included in the storage object;
re-serializing the storage object, to be a re-serialized storage object, without the file of the group of files used to create the updated file; and
transmitting, via at least one of a wired or wireless computer network, the re-serialized storage object to the storage equipment.

16. The non-transitory machine-readable medium of claim 15, wherein the retrieving of the storage object from the storage equipment is initiated by an archival process executing on one of the at least one processor.

17. The non-transitory machine-readable medium of claim 16, wherein the archival process is a background process that becomes a foreground process at a defined time interval.

18. The non-transitory machine-readable medium of claim 15, wherein the operations further comprise, subsequent to the transmitting of the storage object to the storage equipment, waiting for a defined period of time for acknowledgement receipt data to be returned from the storage equipment, and wherein the acknowledge receipt data indicates that the storage object has been persisted to the storage equipment.

19. The non-transitory machine-readable medium of claim 18, wherein the operations further comprise, in response to the acknowledge receipt data being determined not to have been received within the defined period of time, re-transmitting the storage object to the storage equipment and setting a generic system clock timer for a defined time duration.

20. The non-transitory machine-readable medium of claim 19, wherein the operations further comprise, in response to the acknowledgement receipt data being determined not to have been received within the defined time duration, as determined by the generic system clock, moving the storage object into a temporary memory cache and initiating a back off time period measured by the generic system clock.
